(19) United States
(12) Patent Application Publication
(10) Pub. No.: US 2019/0236577 A1
(43) Pub. Date: Aug. 1, 2019

(54) CUSTOMIZABLE AND FLEXIBLE PAYMENT PLANS

(71) Applicant: PARTIALLY INC., Tampa, FL (US)

(72) Inventors: Andrew SCHMID, Tampa, FL (US); Benjamin SCHMID, Tampa, FL (US)

(21) Appl. No.: 15/881,687

(22) Filed: Jan. 26, 2018

(51) Int. Cl. G06Q 20/24

(52) U.S. Cl. CPC G06Q 20/24

(57) ABSTRACT

A software platform implementing a payment plan option for customers purchasing goods and services from a merchant website has an intuitive and transparent customer experience. The customer is able to calibrate down payment, frequency, and duration of the payment plan using user interface elements that show all values and periods being adjusted as the customer is making modifications to the payment plan. The platform allows the merchant to offer payment plans where customers can pay on specific days of the month. Customers can change payment plan terms after the plan has been agreed to and memorialized in a plan agreement containing the payment schedule. When terms have been changed, a replacement agreement is created and replaces the prior agreement. A plan can have automatic scheduled payments or manual payments. For manual payments, the merchant is able to select multiple manual plans for which he wants payments made and submit the batch of manual payments in parallel or concurrently.

### BACKGROUND OF THE INVENTION

### 1. Field of the Invention

The present invention relates to software for managing payments plans. More specifically, it relates to a software platform for enabling creation of payment plans and payment schedules for payment of goods and services wherein merchants and customers are able to customize parameters and guidelines in a visually intuitive manner.

### 2. Description of the Related Art

Online shopping for goods and services has grown rapidly over the last several years. Consumers now shop online not only for products, but for a wide variety of services and events, such as travel bookings, medical services, education (e.g., paying for online classes and seminars), entertainment (e.g., buying tickets for an event), among others. Merchants and providers of products and services would like to maintain this upward trend and are always looking for ways to streamline their businesses and make it easier for consumers to purchase or subscribe to whatever it is they are offering so they can increase sales and revenues.

One area that has not been tapped for its full potential in facilitating and promoting online purchases is the opportunity of payment plans. Consumers are sometimes offered payment plans or store credit cards when purchasing goods from retail stores. In another era, some of these offers were referred to as lay-away plans and the like. These plans made it easier for consumers to afford large-ticket items, such as furniture and appliances. However, this convenience, which benefits both consumer and merchant, has not seen widespread use or acceptance in the online world. Some online merchants do offer consumers a payment plan option at checkout. Although this is movement in the right direction, these plans are rigid and offer little flexibility to the consumer. Typically, the only flexibility or options provided to the customer is the term, also referred to as duration, of the payment plan. For example, the consumer may only be able to select how long he wants the payment schedule to be before it is fully paid, such as three months, six months, one year, and so on. Moreover, many of the payment plans presently offered have non-intuitive or clumsy interfaces making it a difficult or unpleasant experience for the consumer. Many consumers would like to have the option of starting a payment plan, especially for larger purchases online, or make pre-payments for a future release, simply to make such purchases financially feasible. However, this option has not been made viable. As a result, online payment plan offerings have been limited and have generally failed to benefit consumers or fuel growth for online merchants and service providers.

It would be desirable to have online payment plans that provide consumers flexibility and options. Furthermore, it would be desirable if such plans were easy for the consumer to use and for the merchant or service provider to manage.

### SUMMARY OF THE INVENTION

In one aspect of the present invention, a service provider offers a flexible payment plan software platform to merchants which a merchant can use to give customers the option of paying via a payment plan. The platform allows the merchant to give a customer the opportunity to pay for a good or service over a period of time. Once the option is selected, the customer sees in very clear terms all relevant details of the plan. In one embodiment, the customer can use a first user interface element to adjust the down payment with limits set by the merchant, a second user interface element to adjust the duration of the plan, and a third element to adjust the frequency of payments, all with upper and lower limits set by the merchant. In another user interface element, a payment plan overview is provided in which all relevant amounts and time periods are provided in clear terms and with transparent language that explains the payment plan. The user interface elements allow a customer to easily calibrate or micro adjust down payment, duration, and frequency, in order to arrive at a suitable payment amount. In another embodiment, the merchant offers a payment plan where specific days of the month (e.g., 1, 15, and 22 days of each month) can be designated as payment dates. In another embodiment, a merchant can offer what may be referred to as “final payment date” term. With this plan option, all payments for a good (e.g., tickets for an event on a specific date) are scheduled to be completed before a final payment date (e.g., event date). The platform will calculate the maximum number of payments possible according to the customer-selected payment frequency.

In another embodiment, a customer changes the terms of a payment plan (within the limits set by the merchant). The original agreement that formalized the initial payment plan and contains specific information on the plan, including payment amounts and payment dates, is replaced with a new plan agreement. The new plan agreement reflects new terms set by the customer. Both agreements are stored by the service provider and can be easily accessed by customer and merchant.

In another aspect of the present invention, the merchant has the option of offering a customer an automatic payment plan where payments are made with minimal or no intervention by the merchant. Another type of plan is referred to as manual and requires that the merchant manually select customer payment plans for which payments need to be made. The platform provides a merchant-facing portal screen that lists payments plans for the merchant. There is a column indicating which ones are automatic and manual and an interface element, such as a check box, for each plan. The merchant can select multiple manual plans using the interface element. The merchant can then submit all selected plans at once for bulk processing. This enables a merchant to process payments for multiple plans (e.g., 100s or 1000s) in a single batch and the software platform will process all selected manual payments concurrently.

### BRIEF DESCRIPTION OF THE DRAWINGS

FIG. 1A is an initial screen shot of a flexible payment plan interface shown to a customer in accordance with one embodiment;

FIG. 1B is a second screen shot of the flexible payment plan interface as seen by the customer in accordance with one embodiment;

FIG. 2 is a screen shot where a customer can dynamically adjust payment plan terms;

FIG. 3 is a screen shot of a checkout screen for a customer;

FIG. 4 is a screen shot of a merchant portal from where a merchant can get an overview of various payment plan and customer metrics; and

FIG. 5 is a screen shot of a payment plans page that can be viewed by a merchant and lists all automatic and manual payment plans from customers.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting. On the contrary, it is intended to cover alternatives, modifications, and equivalents as may be included within the spirit and scope of the present disclosure as defined by the appended claims.

For example, methods and systems of the present disclosure are described in the context of purchases made on the Internet, specifically from online retailers and service providers, some of whom may have brick-and-mortar or physical stores or retail offices. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure. Various techniques and mechanisms of the present disclosure will sometimes be described in singular form for clarity.

However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

The present invention is a method for enabling online merchants and service providers to offer flexible and transparent payment plans to customers and for customers to utilize these payment plans through an intuitive user interface. In the described embodiment, there are three parties or entities: the online merchant or service provider (“merchant”), the customer, and service provider operating the payment plan software platform. The software as a service platform implemented by the service provider enables the merchant to quickly and easily offer to the customer flexible payment plans to pay for goods or services. The customer proceeds as she normally would through the merchant's site, placing items in a shopping cart, or something similar. The novel and non-obvious processes of the present invention begin—from the customer's perspective—at checkout time. Before this, the merchant performs several steps with the service provider to enable or set-up the payment plan to be used on the merchant's website. Before describing the processes taken by the merchant to set up the payment plans on the merchant's site, it is helpful to describe a typical scenario illustrating how a customer would use the payment plan option.

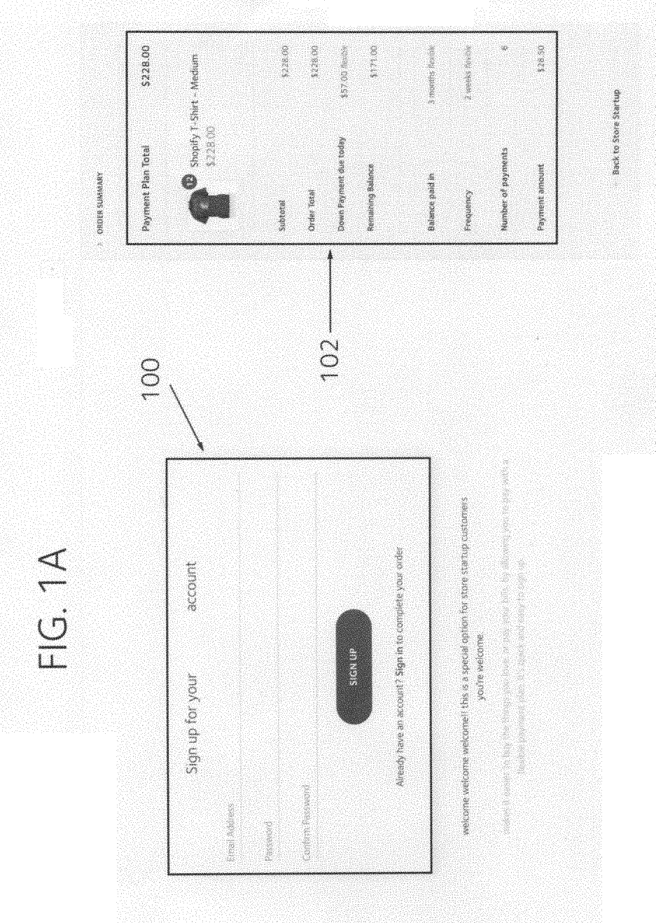

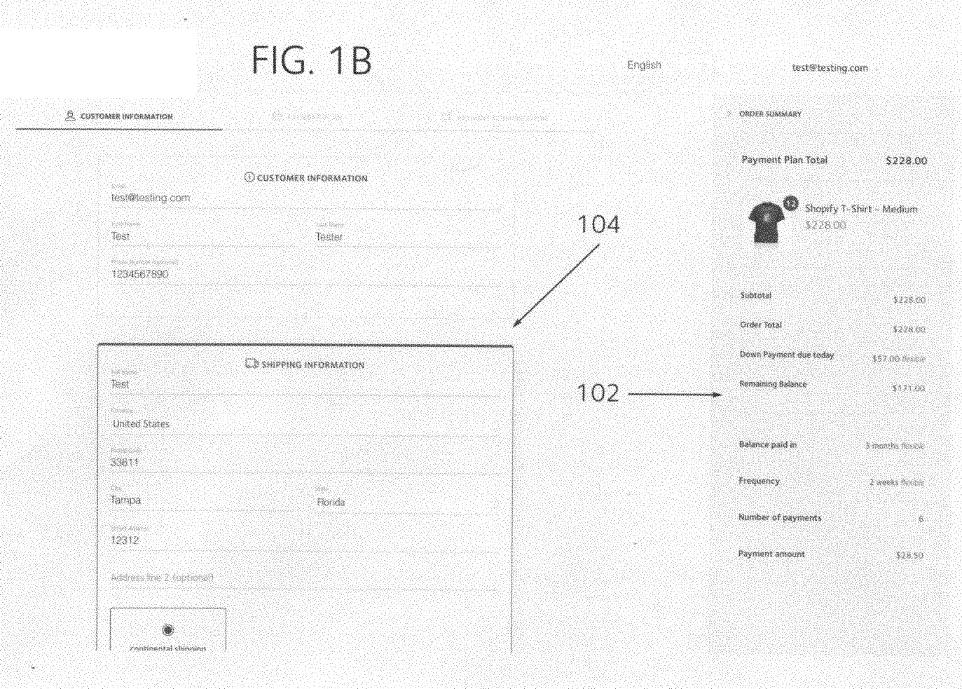

A customer visiting an online store places items (e.g., products, services, packages, tickets etc.) in a shopping cart and is ready to checkout and pay for the items. The merchant has a “Flexible Payment Plan” option (or something similar) on the checkout page. The customer clicks on the link for the option and is taken to a new page. An example of this page is shown in FIG. 1A. The new page has the merchant's name and logo at the top to assure the customer that he has not left the merchant site or is at least still in direct communication with the merchant (if on a different platform but transparent to the customer). The customer enters login information in window 100 for logging into her account with the service provider. The service provider implements the flexible payment plan for the merchant. An order summary column 102 is also shown and described below.

After the customer has logged in or has created an account with the service provider, a second screen as shown in FIG. 1B is displayed. The customer enters contact information, shipping address, and other information, if needed in window 104. This information may be pre-filled if the customer is registered with the service provider or merchant.

On the right side of the screen is a dynamic list 102 of relevant line items. In one embodiment, these items include the total amount due for the items purchased (referred to as “subtotal”) and a service fee charged by the merchant for using the payment plan (not shown in column 102). For example, the merchant can set this fee anywhere from 1% to 5% of the subtotal or it could be a flat fee. In the described embodiment, this is the only fee or cost to the customer for using a payment plan. There is no interest rate, APRs, and the like, in the payment platform. Other line items may be taxes and shipping charges. These line items are added to reach an Order Total, also referred to as a Payment Plan Total, which may be displayed in bold at the bottom and top of line item list. The merchant may have a default down payment percentage, such as 20%, which is also shown as a line item (“Down Payment due today”). This amount is shown next to a label, such as “flexible” making it clear to the customer that this can be changed. The next line item is Remaining Balance. The payment schedule is applied to this remaining balance.

The merchant may have default values for the payment schedule, all shown below the Remaining Balance figure. One is Duration (or Term), such as 3 months, accompanied by the label “flexible.” Another item is Frequency of Payment. The default set by the merchant may be every two weeks or once a month. Again, this is accompanied by the label “flexible” to let the customer know that this can be changed. The platform uses the Remaining Balance value and the default payment schedule values to automatically calculate the “Number of Payments” the customer will need to make and the “Payment Amount.” In this manner, at this stage the customer already has an idea of what a payment schedule would look like if she were to go with the default (or conventional) payment guidelines. However, with the platform of the present invention, she can go to the next step and select “Continue to Plan Terms.”

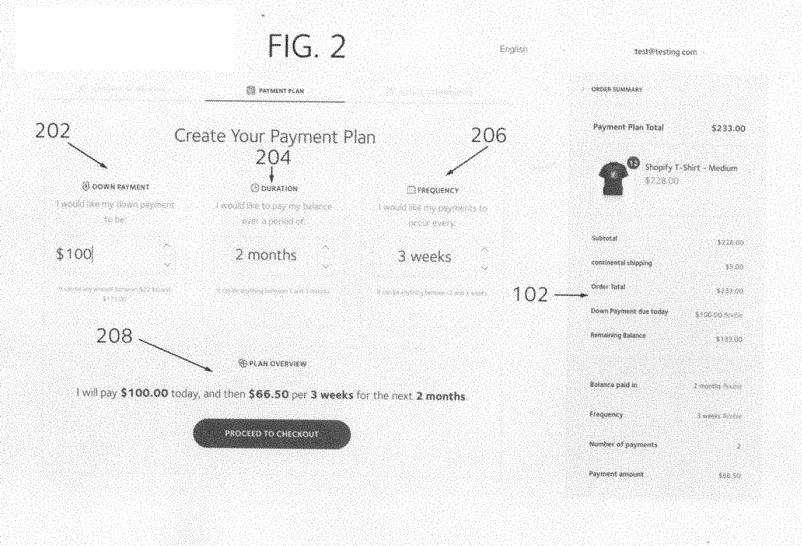

At this page, the customer can adjust the payment plan to suit her needs. An example is shown in FIG. 2. The dynamic line items are still shown at one side of the page, so all the relevant values are visible to the customer. The interface is intuitive, clear, and transparent, and provides immediate feedback. The customer is presented with three boxes: Down Payment 202, Duration 204, and Frequency 206. For Down Payment, the merchant may have minimum and maximum percentages (e.g., 10% to 50%). The customer actually sees what the dollar values are for each whole number percentage in this range is. The down payment box may state “It can be any amount between $102.00 and $510.00.” As such, the customer sees what is actually relevant, that is, actual dollar values, not percentages. The customer can adjust the amount by using up and down arrows, or directly entering an amount, thereby being able to fine-tune or calibrate the down payment. The same can be done with duration, that is, the period of time within which the customer would like to pay off the balance. The merchant provides the limits here as well (e.g., “It can be anything between 1 and 6 months.”). The customer can adjust the term using up and down arrow keys in one-month increments. In other embodiments, it may be weekly increments. Finally, the customer can decide how often she would like to make payments, that is, the frequency, by one week increments. Again, the merchant can set parameters, such as “It can be anything between 1 and 4 weeks,” allowing the customer to make as many as 4 payments a month or one payment a month.

Below the three boxes for Down Payment, Duration, and Frequency, is a Plan Overview window 208. One of the key features of the user experience offered by the platform is dynamic, calibrated adjustments to the down payment value, the payment plan amounts, the frequency and duration. The values for all these are changing dynamically as the customer adjusts down payment, duration and frequency. Keeping in line with the clean and intuitive interface of the platform, the Plan Overview may provide “I will pay [$xxxx] today, and then [$yyyy] per [n weeks] for the next [m months]” The values for x, y, n and m change as the customer adjusts them in their respective windows or boxes. They are also changing in the dynamic line item column 102 in FIG. 1 displayed on the page in the same way they are in the Plan Overview window. That is, the values for down payment, payment amount, frequency, and duration are the same in both areas. The Plan Overview window may say “I will pay $204.62 today, and then $135.90 per 2 weeks for the next 3 months. The bold values are all flexible and customers can adjust each one to suit their financial needs, with upper and lower limits set by the merchant.

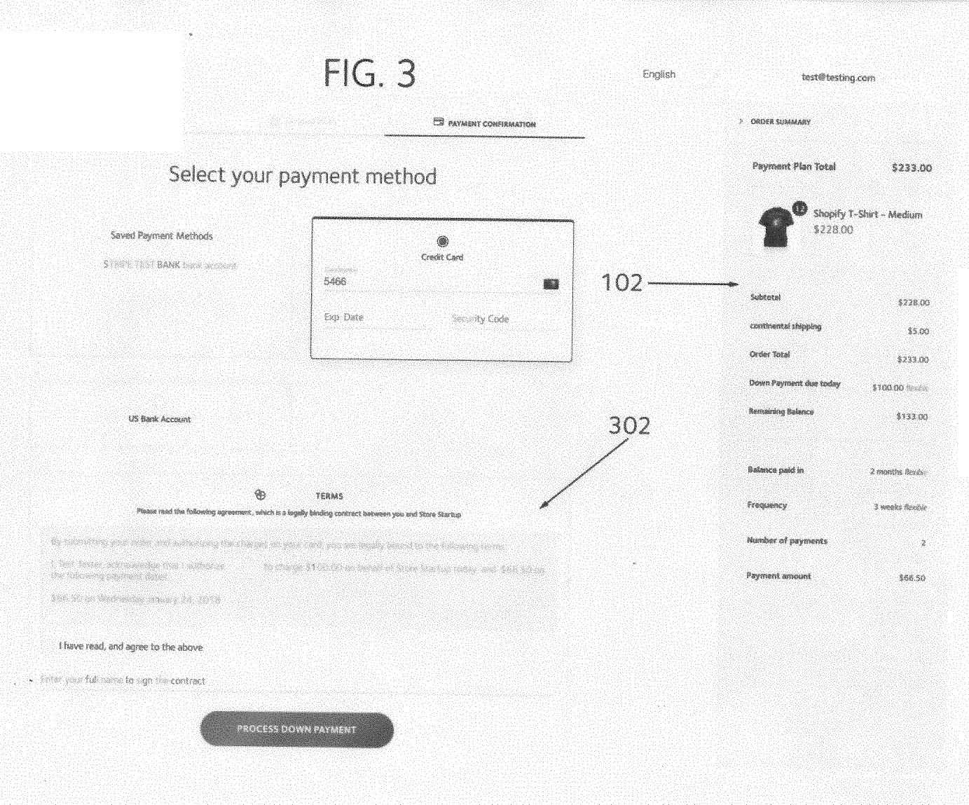

Once the payment plan terms are set by the customer, she can proceed to checkout. An example of a checkout screen is shown in FIG. 3. Here she pays the down payment using conventional means, such as a credit card or bank account. The dynamic line items column 102 is shown persistently on the side so the customer can still see the payment plan terms and all relevant values. On this screen is a box 302 that contains the plan agreement, a legally binding contract between the customer and the merchant. The agreement is dynamically generated and contains specific values for all relevant terms. In addition, it provides actual payment values due on specific dates (“dates certain”). It states that the buyer will pay the full amount by a certain date, provide alternative payment methods if needed, and other provisions. The customer checks a box stating she has read and agrees to the contract. She signs it by typing her name. She then clicks “Process Down Payment” and the first payment is charged to the selected payment method.

A non-modifiable PDF of the contract is securely stored with the service provider, where it is accessible for future reference by both merchant and customer, and is emailed to the customer. The customer now has a payment plan with the merchant. This payment plan has a first or initial payment schedule and an initial contract. However, as described below, the payment plan can be modified by the customer within limits set by the merchant, or by the merchant or service provider. If this is done, the payment plan will have a second payment schedule and a second contract (both of which reflect the adjustments made) and both of which replace the first schedule and first contract. The first schedule and contract are still stored and accessible to merchant and customer but are no longer valid.

The second contract will have a first payment date that is at some date on or after the execution date of the second contract. The number of payment dates and the payment amounts will also be different, depending on the changes made by the customer. Notably, the final payment date may be after the previous final payment date if the customer extended the duration. However, in one embodiment, the duration limits that applied when the customer created the first payment plan are still in effect, thereby preventing the customer from indefinitely extending the duration of the payment plan.

The customer can go back and modify terms of the most recent payment schedule thereby creating a new contract, and proceed with payments all associated with, that is, going towards the original payment plan. As noted, following good practices in the industry, all schedules and contracts are saved by the merchant and non-modifiable PDFs are always provided to the customer that can be accessed, for example, if there is a payment dispute and the like.

The scenario described above illustrates a typical payment plan that can be characterized as “automatic.” Here the payments are automatically charged from the customer's credit card or bank account on the scheduled dates. No actions are taken by the merchant or the customer unless criteria of the agreement are violated. This allows the merchant to streamline her business, keep the business efficient, and scale. It would not be unusual for a merchant to be able to efficiently manage thousands of customer payment plans through a merchant portal.

In one embodiment, the merchant may create multiple payment plan “offers.” As noted, which offer is shown to a customer may depend on whether the customer is a preferred customer or regular customer. It may also depend on the total value of the goods or services the customer is buying or the number of items in the customer's shopping cart. If the merchant determines the customer is preferred (or is a member, a repeat customer, or has a promotion code, etc.), the offer may be one that has a lower service fee, such as 1% or 2%, which is displayed on the first screen when the customer selects the Payment Plan option. If the customer is identified as a regular customer, the default service fee may be 5%. In one embodiment, the merchant and service provider may derive revenue from the payment plan platform stemming from the service fee.

In one embodiment the merchant can provide different payment plan offers to customers based on the dollar value of the purchase, the number of items being purchased, or combinations thereof. This can be done by examining the contents of the shopping cart when the customer first invokes or clicks on the “flexible payment plan” link at the checkout stage on the merchant's website. When the customer selects that option, a script or other code in the merchant's shopping cart routine and executed by the payment plan service provider examines the content of the cart. Depending on the factors mentioned (value, quantity, and the like), a specific offer can be made to the customer. Which offer is made is transparent to the customer. The service provider collaborates with the merchant to derive the different payment plans that can be offered. One plan may have specific “days of the month” payment frequency or a lower service fee percentage, both of which are beneficial to the customer. For typical customers (e.g., non-repeat and below a high threshold dollar value), a standard or conventional payment plan may be offered, again, all transparent to the customer. In one embodiment, the merchant can inform the customer that she is getting a better payment plan offer because of her purchase or because she is a repeat customer, for example.

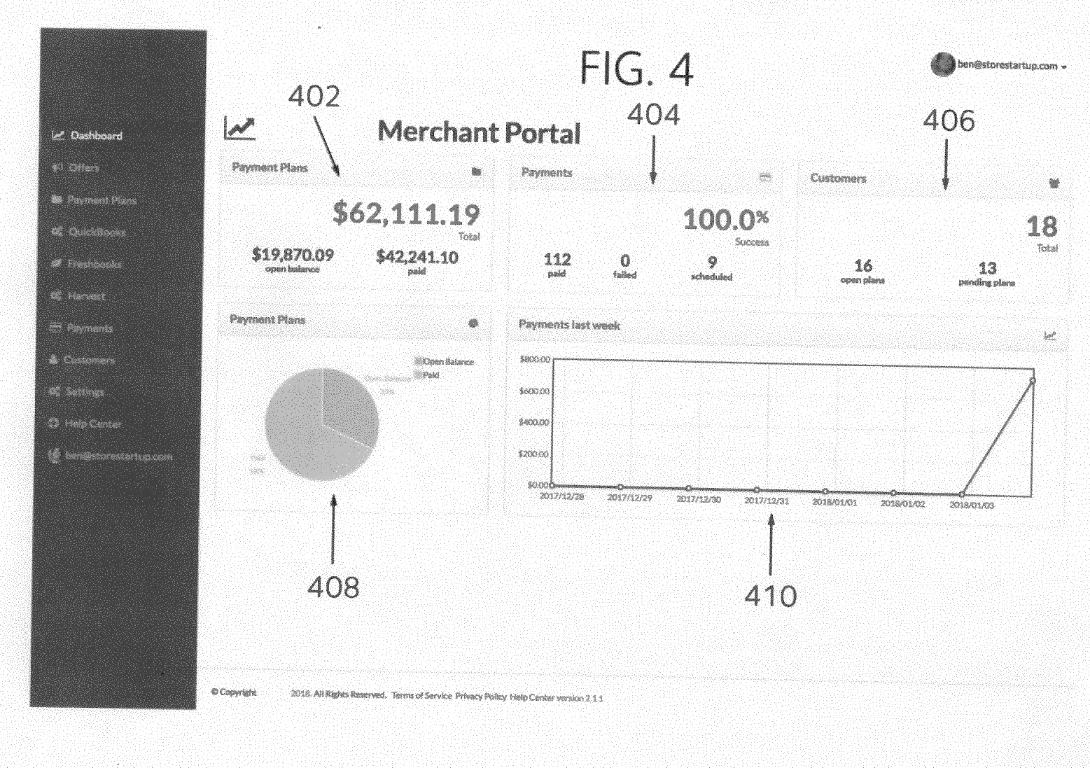

The software as a service platform used to implement the described payment plans is offered by the service provider for use by the merchant. As such, the merchant will likely have many payment plans from multiple customers. In one embodiment, the platform provides a merchant portal screen that summarizes the current status of all the merchant's outstanding or open plans with customers. An example of a merchant portal screen is shown in FIG. 4. Here the merchant can get an overview of various metrics, such as the total amount of all payment plans, percentage of open payment plan balances vs. paid amounts, number of successful and failed payments, payment success rate, number of customers, and daily totals of payments for the previous week.

There are various embodiments of the payment criteria described above. One novel variation is referred to as “days of month” payment frequency. In one embodiment, this allows the merchant to set specific days of the month on which the customer is required to make payments. The merchant may require that the customer make payments on the 1^{st}, 15^{th}, and 21^{st} days of each month or only on the 1^{st} and 15^{th}. When the merchant includes this feature in its payment plan offers, on the customer-facing terms page (e.g., “Create Your Payment Plan” page), the customer will not see the “Frequency” box or may only see the merchant's statement that payments are required on these specific days of the month.

The customer can adjust the down payment and duration criteria to see how much the payment amounts would change given the fixed payment frequency. The merchant can enter fixed payment dates when creating the offer, for example, by checking a “Days of Month” frequency box 402 and entering “1, 15, 22” indicating the days of the month. In this example, payments will be charged on those specific calendar days (the 1^{st}, 15^{th}, and 22^{nd} days of each month). In another embodiment, the software platform enables the option of giving the customer the ability to set frequency criteria, as described above, but also the days of the months on which payments will be made, further extending the flexibility to customers for creating their payment plans.

Another type of payment plan offered on the platform and one that can be offered to customers is a manual payment plan. These types of payment plans are generally suitable for products that have not yet been manufactured, where customers essentially pre-order a product. Another scenario may be a customer purchasing tickets for an event where the date has not been set or not known at the time of purchase. Or the date is known and the customer makes a down payment and agrees to make one or more payments before or on the date of the event. These subsequent payments are referred to as manual payments; payments that are manually processed by the merchant through the merchant portal using the platform. The merchant may describe payment terms to the customer generally, for example, “We will bill you when production is complete, between 2 and 4 weeks” or something similar. This description appears in the contract signed by the customer. This is described in more detail below.

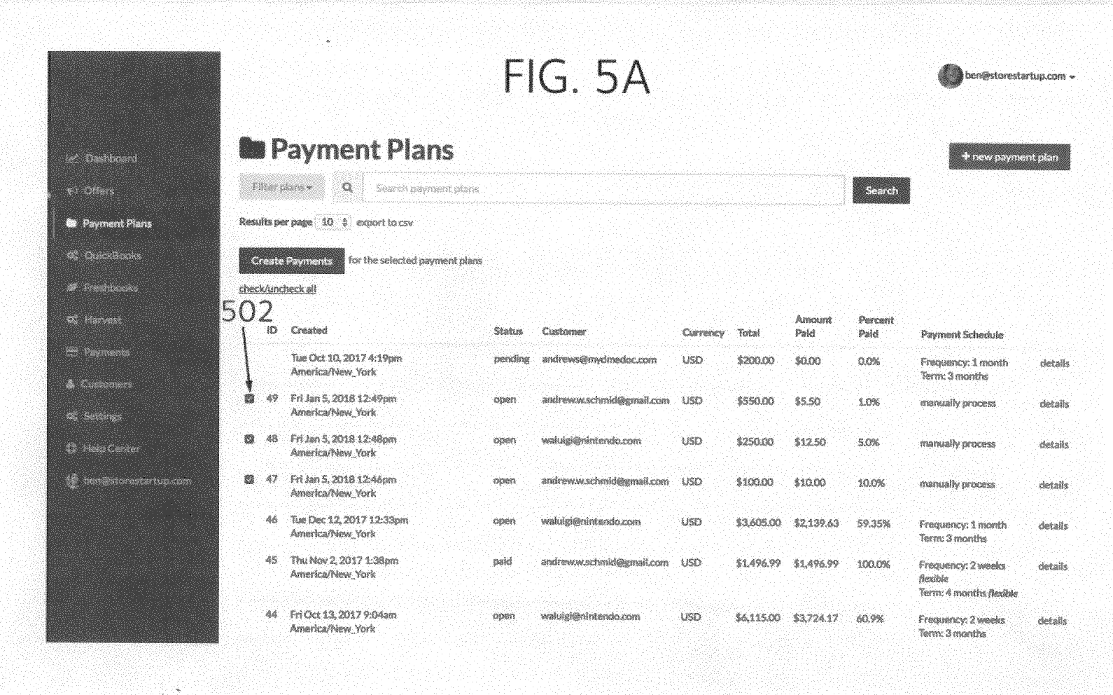

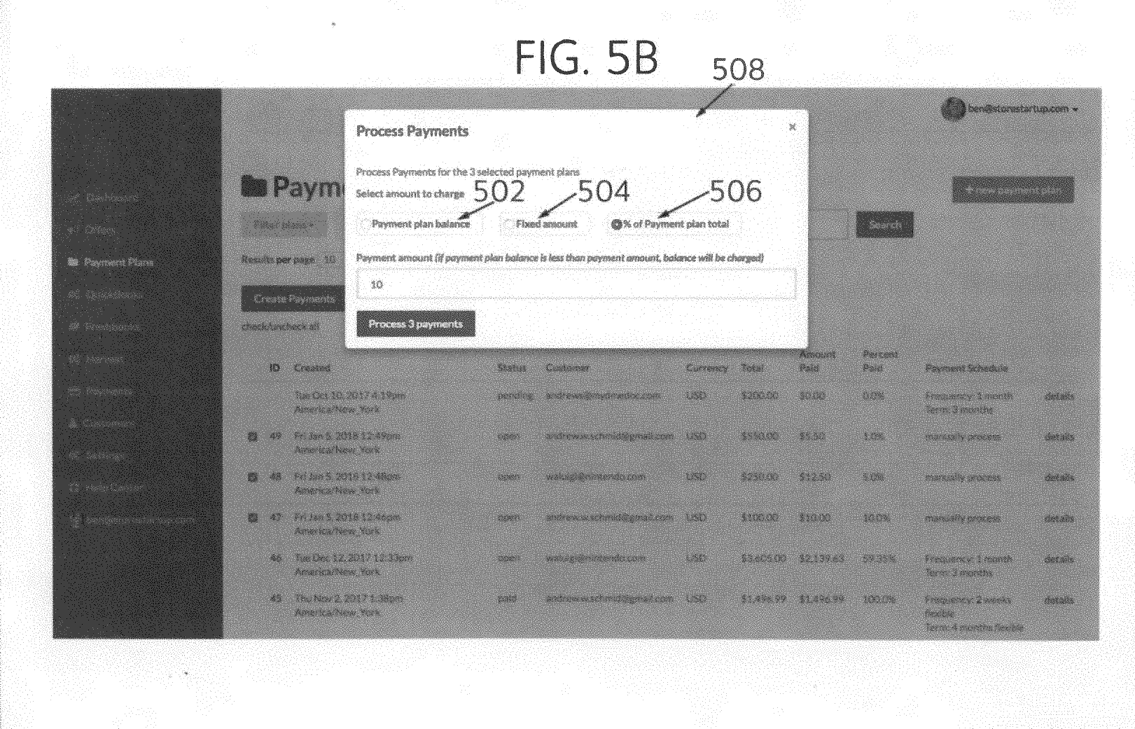

With manual payment plans, the merchant goes to a “Payment Plans” page in the merchant portal which lists all automatic and manual payment plans from all customers. An example is shown in FIG. 5. Each line or entry provides an ID for the plan, date created, status, customer email, currency, total amount for the plan (total amount for goods, services, etc. plus fees and taxes, minus the down payment), the amount paid so far, what percent the amount paid is of the total, and a payment schedule type. Here it can say either “manually process” or, if automatic, provide frequency and term (e.g., Frequency: 1 week; Term: 1 month). For all manual payment plans, there is a check box 502 to the left of the ID (or somewhere easily visible for that entry).

As noted, the merchant is required to process payments manually. That is, she decides when it is the right time to charge the customer's credit card (or other payment method) for the next payment. The merchant is able to do this by performing bulk processing of payment batches. There may be hundreds of such manual plans. The merchant can check boxes 502 for all manual payment plans for which she wants to process a payment. Once all the boxes are checked, the merchant may have one of 1) payment plan balance, 2) a fixed amount, 3) or a percentage of the plan total, be paid.

In one embodiment, all the manual plans, for which the plan balance is going to be processed, are checked in one batch. That is, only boxes for those plans are checked. The merchant submits them, and bulk processing for that batch is run. As a result, payment plan balances for all those checked entries are charged (and the status may go from “open” to “paid”). The merchant may then check all the boxes for plans in which she wants to charge the same fixed amount. After those boxes are checked and she enters that fixed amount in a “Process Payments” window 504, those entries are processed in another batch. The “amount paid” and “percent paid” values (noted above) are modified accordingly. The same can be done for the “percentage of plan total” option. The boxes are checked and in Process Payments window 504, the merchant enters the percentage of payment plan total to be paid. In this manner, merchants can browse all open payment plans, select any number of them at one time, select one of the three ways to charge (i.e., balance, fixed, or percent), and have those processed in one batch.

As noted, in the payment plan contract, a description of the payment schedule entered by the merchant (e.g., “We will bill you when production is complete, between 2 and 4 weeks”) will appear in the contract, specifically in the section that states how much the remaining balance is (after the customer has paid the down payment) and that it will be paid according to the schedule described by the merchant.

Therefore, it is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

What is claimed is:

1. A method of implementing a payment plan comprising:
accepting input from a merchant website, said input signaling a customer initiating creation of a first payment plan, and including a first total value;
displaying a first customer interface screen including the first total value in an order summary window, also including a down payment window, a duration window, and a frequency window;
receiving down payment adjustment input, duration adjustment input, and frequency period adjustment;
displaying a payment plan overview window displaying an actual down payment value, an actual installment payment value, an actual frequency, and an actual duration;
wherein the actual down payment value, the actual installment payment value, the actual frequency period and actual duration period dynamically reflect customer calibrations to a down payment value and to a duration period and a frequency period;
displaying in a second customer interface screen a first payment plan agreement containing a first payment schedule based on final down payment value, installment payment value, final frequency period, and final duration period;
receiving plan modification input directly modifying the first payment plan agreement, thereby canceling said first agreement;
replacing the first payment plan agreement with a second payment plan agreement reciting updated plan terms reflecting said plan modification input; and
displaying the second payment plan agreement for acceptance by the customer.

2. A method as recited in claim 1 further comprising:
maintaining a payment plan agreement history by storing said first payment plan agreement and said second payment plan agreement.

3. A method as recited in claim 1 wherein the plan modification input is an unscheduled installment payment thereby adjusting the installment payment value.

4. A method as recited in claim 1 further comprising:
displaying an order summary in the order summary window providing payment overview details, said order summary adjusting as down payment adjustment input, duration adjustment input, and frequency period adjustment input are received.

5. A method as recited in claim 1 further comprising:
displaying minimum and maximum values of acceptable down payment values, minimum and maximum acceptable duration periods, and maximum acceptable frequency periods.

6. A method of managing multiple payment plans comprising:
displaying a first merchant interface screen showing payment plan overview data generally relating to multiple payment plans, each payment plan associated to a customer of a merchant;
displaying a second merchant interface screen showing a payment plan list showing including specific data for each payment plan, including payment schedule type for each payment plan, said schedule type being one of automatic or manual;
enabling selection by the merchant of a subset of the multiple payment plans for manual processing, wherein the merchant intentionally selects one or more plans to be processed for payment as a single batch of manual payments;
displaying a third merchant interface screen showing options for fixed amount, a percentage of balance, or full balance; and
enabling selection of processing a fixed amount for payment, a percentage of balance payment, or a plan balance payment.

7. A method as recited in claim 6 further comprising:
receiving the single batch of manual payments for parallel processing.

8. A method as recited in claim 6 further comprising:
enabling the setting of a final payment date for a payment plan; and
adjusting pay frequency period for the plan, wherein a maximum number of installment payments is determined based on payment frequency.

9. A method as recited in claim 6 further comprising:
receiving one or more specific days of month as input indicating installment payment dates.

10. A method as recited in claim 6 further comprising:
enabling the scheduling of installment payments on specific calendar days of the month.

11. A method as recited in claim 6 further comprising:
receiving a fixed amount for payment value.

12. A method as recited in claim 6 wherein specific data for a payment plan includes plan creation data and payment schedule data.

13. A method as recited in claim 6 wherein payment plan overview data includes total open balance and total paid amount relating to all payment plans for the merchant; successful payments, failed payments, and scheduled payments; and number of customers on payment plans including open plans and pending plans.
